(19) United States
(12) Patent Application Publication
(10) Pub. No.: US 2026/0168543 A1
(43) Pub. Date: Jun. 18, 2026

(54) SELECTABLE CLUTCH

(71) Applicant: TSUBAKIMOTO CHAIN CO., Osaka (JP)

(72) Inventors: Yuma Ishihara, Osaka (JP); Tsubasa Sugiya, Osaka (JP); Hirokazu Tsuneda, Osaka (JP)

(73) Assignee: TSUBAKIMOTO CHAIN CO., Osaka (JP)

(21) Appl. No.: 19/415,973

(22) Filed: Dec. 11, 2025

(30) Foreign Application Priority Data
Dec. 12, 2024 (JP) 2024-217676

(51) Int. Cl. F16D 41/12; F16D 41/04

(52) U.S. Cl. CPC F16D 41/125; F16D 41/04

(57) ABSTRACT

Provided is a selectable clutch that is capable of switching between operation modes with a simple structure, provides high responsiveness, is capable of ensuring a desired torque capacity, and integrates a drive source for operation into a device to achieve a compact configuration. The selectable clutch includes a clutch mechanism and an operation mechanism, and is capable of switching between transmitting and blocking relative rotation of a first rotation element and a second rotation element. The operation mechanism includes a main body part, an annular connection plate provided unable to move in an axial direction with the first rotation element, and a drive unit provided in the main body part and driving the connection plate in the axial direction. The main body part is configured to be capable of supporting a shaft member connected to the first rotation element or the second rotation element by a bearing.

### BACKGROUND OF THE INVENTION

### 1. Field of the Invention

The present invention relates to a selectable clutch including a clutch mechanism that transmits and blocks rotation of a first shaft and a second shaft provided to be capable of relative rotation on the same axis and an operation mechanism that switches operations of the clutch mechanism, the selectable clutch being capable of switching between transmitting and blocking the relative rotation of the first shaft and the second shaft.

### 2. Description of the Related Art

A two-way clutch capable of switching between driving and idling in both a normal direction and a reverse direction is known as a clutch for controlling the transmission and blocking of rotation between two shafts.

Although devices incorporating a ratchet clutch or a dog clutch are well known, these devices can transmit rotation only at a prescribed rotation angle and through rigid engagement, which makes backlash likely to occur and produces loud noise.

Certain types of two-way clutches are configured to enable switching between a locked state in which relative rotational movements of inner and outer rings are prohibited (rotational force is transmitted) and a free state in which relative rotational movements of inner and outer rings are permitted (rotational force is blocked) by tilting cams or sprags, and to transmit rotation at a desired rotation angle (see, for example, Japanese Patent Application Publication No. 2011-220509 and Japanese Patent Application Publication No. H11-182589).

Further, Japanese Patent Application Publication No. 2014-219015 discloses a two-way clutch including a switching mechanism capable of switching between three operation modes, namely a two-way free mode, a one-way lock mode, and a two-way lock mode, and transmitting rotation at a desired rotation angle, by controlling a cage that holds a roller serving as a power transmission member in a neutral position or one engagement position of a cam surface formed on the inner circumference of the outer ring.

### SUMMARY OF THE INVENTION

In the two-way clutch disclosed in Japanese Patent Application Publication No. 2011-220509, when the input side rotor rotates relative to the output side rotor, the sprags tilt in the same direction as the rotation direction of the input side rotor, thereby switching the engagement and disengagement between the input side rotor and the output side rotor, and therefore when the rotation direction changes, a time loss occurs, resulting in poor responsiveness. A similar problem arises in the two-way clutch disclosed in Japanese Patent Application Publication No. H11-182589 as well.

Although the two-way clutch disclosed in Japanese Patent Application Publication No. 2014-219015 is capable of transmitting power in both directions simultaneously using a leaf spring-like member, the torque that can be transmitted is small relative to the size of the two-way clutch due to the friction-based power transmission.

In order to address such issues and provide a cam clutch that enables switching between operation modes with a simple structure, offers high responsiveness, and ensures a desired torque capacity, the applicant has invented a cam clutch incorporating the operation mode switching mechanism disclosed in Japanese Patent Application Publication No. 2020-190255.

However, in these publicly-known two-way clutches, an operation force must be input to perform the switching operation, but a drive source for the operation force must be provided separately and is therefore not integrated as a device including the entire operation mechanism.

Additionally, in the clutch types that lock by sandwiching cams, the cams can lock at any position in each direction, and a slight relative rotation after the start of torque transmission causes the cams to more firmly engage and transmit torque. Therefore, in the two-way lock mode, even if the rotational torque disappears, a slight relative rotation that occurs when the engagement on one side is released causes the cams on the other side to engage, and as a result, the engagement of the cams remains in both directions.

In order to switch to the two-way free mode or the one-way free mode in this state, a force to release the engagement of the cams is required, and since the degree of engagement increases as the transmission torque increases, it has been necessary to provide a switching mechanism having a structure capable of generating a large force when transmitting a large torque.

The present invention is directed to solving these problems, and it is an object of the present invention to provide a selectable clutch that is capable of switching between operation modes with a simple structure, provides high responsiveness, is capable of ensuring a desired torque capacity, and integrates a drive source for operation into a device that includes the entire operation mechanism to achieve a compact configuration.

The present invention solves the problems by including at least one clutch mechanism that transmits and blocks rotation of a first shaft and a second shaft provided to be capable of relative rotation on the same axis and an operation mechanism that switches an operation of the at least one clutch mechanism. The clutch mechanism includes a first rotation element fixed in a rotation direction with the first shaft, and a second rotation element rotationally fixed to the second shaft. The operation mechanism includes a main body part, an annular connection plate provided unable to move in an axial direction with the first rotation element, and a drive unit provided in the main body part and driving the connection plate in the axial direction. The main body part is configured to be capable of supporting a shaft member connected to the first rotation element or the second rotation element by a bearing.

According to the feature of Aspect 1, the operation mechanism includes the main body part, the annular connection plate provided unable to move in the axial direction with the first rotation element, and the drive unit provided in the main body part and driving the connection plate, and the main body part is configured to be capable of supporting a shaft member connected to the first rotation element or the second rotation element by a bearing. This makes it possible to reduce and integrate a part of the drive source for operation that protrudes in the radial direction using a simple structure, and configure a device including the entire operation mechanism more compactly.

According to the feature of Aspect 2, a more compact configuration can be achieved when the input direction of the operation force for switching is the axial direction.

According to the feature of Aspect 3, the actuator, the plunger, and the connection plate are disposed in an annular shape around the first shaft, which makes it possible to transmit the drive force evenly around the entire circumference of the inner ring, reduce the drive force for switching, and make the actuator more compact and consume less power.

According to the feature of Aspect 4, the main body part is formed in a shape enclosing at least one clutch mechanism and the operation mechanism, which makes it possible to make the main body part an integrated unit as a device including the entire operation mechanism.

According to the feature of Aspect 5, the clutch mechanism includes a first clutch mechanism and a second clutch mechanism, the first clutch mechanism includes a locking member that moves and/or rotates between the first rotation element and the second rotation element, and is configured to be capable of transmitting rotation at any rotation angle, and the second clutch mechanism is configured to be capable of transmitting rotation at a predetermined rotation angle by engaging a first engagement element with a second engagement element. Accordingly, the first clutch mechanism is capable of transmitting rotation at any rotation angle, and is therefore capable of backlash-free rotation transmission in both directions in the two-way lock mode. Furthermore, relative rotation occurring when rotational torque disappears and the first clutch mechanism disengages does not cause the second clutch mechanism to engage, and the switching operation can be performed with a small force even when the transmission torque is high.

Furthermore, in the one-way free mode, the first clutch mechanism is used for operation while the second clutch mechanism is disengaged, which enables relative rotation with extremely low noise and rotation resistance.

According to the features of Aspects 6 and 7, since the first clutch mechanism includes what is known as a cam clutch, the operation mode of the first clutch mechanism can be switched with a simple structure, and high responsiveness and a desired torque capacity can be secured.

According to the feature of Aspect 8, since the second clutch mechanism includes a ratchet-type one-way clutch, high responsiveness and a desired torque capacity can be secured.

According to the feature of Aspect 9, the first engagement element is constituted by a plurality of ratchet pawls provided on an end surface of the outer ring, and the second engagement element is constituted by ratchet teeth arranged extending in an outer circumferential direction from an end surface of the inner ring. This makes it possible to make the configuration compact using a simple structure.

### BRIEF DESCRIPTION OF THE DRAWINGS

FIG. 1 is a cross-sectional perspective view of one form of a clutch structure in which part of an operation mechanism is omitted;

FIG. 2 is a cross-sectional perspective view of the form of the clutch structure illustrated in FIG. 1, seen from a different direction;

FIG. 3 is an exploded explanatory diagram of the form of the clutch structure illustrated in FIG. 1;

FIG. 4 is a side view of the form of the clutch structure illustrated in FIG. 1;

FIG. 5 is a side cross-sectional view of the form of the clutch structure illustrated in FIG. 1;

FIG. 6 is a front view of the form of the clutch structure illustrated in FIG. 1;

FIG. 7 is a rear view of the form of the clutch structure illustrated in FIG. 1;

FIG. 8 is an enlarged explanatory diagram of a cam;

FIG. 9 is a cross-sectional perspective view of a selectable clutch according to an embodiment of the present invention; and

FIG. 10 is a cross-sectional perspective view of the selectable clutch illustrated in FIG. 9, seen from a different direction.

### DESCRIPTION OF THE PREFERRED EMBODIMENTS

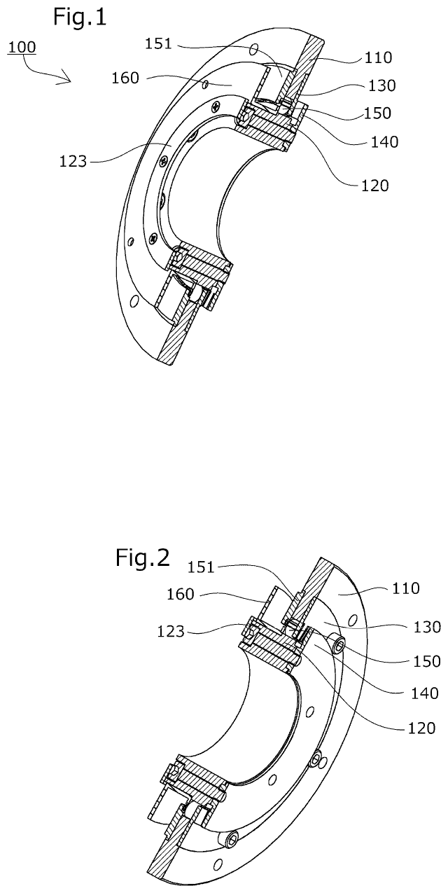

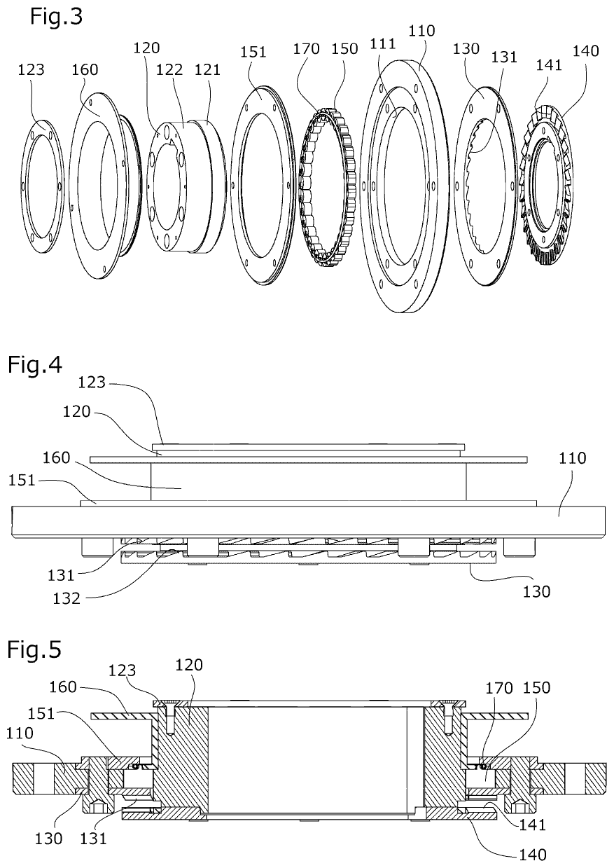

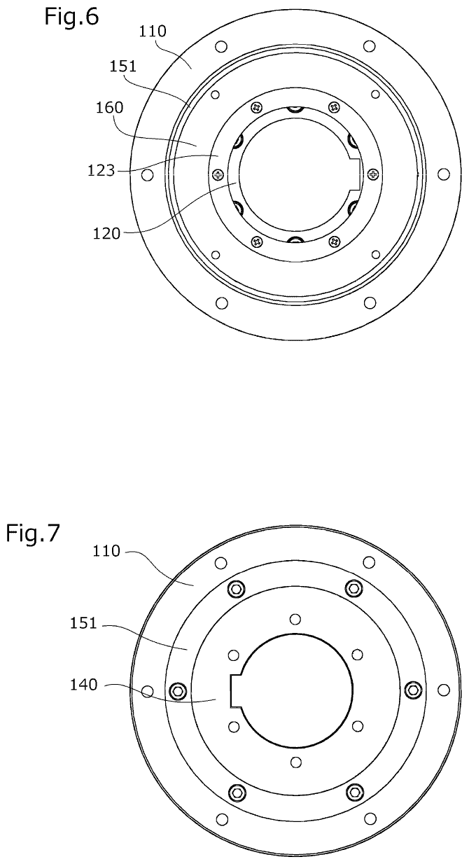

First, one form of a clutch structure in which part of an operation mechanism is omitted will be described with reference to FIGS. 1 to 7. Note, however, that the present invention is not limited to this clutch structure.

As illustrated in FIGS. 1 to 7, a selectable clutch 100 according to one form of a clutch structure that omits part of an operation mechanism includes first and second clutch mechanisms that transmit and block rotation of first and second shafts provided to be capable of relative rotation on the same axis, and an operation mechanism that switches operations of the first and second clutch mechanisms. The first clutch mechanism is a cam clutch provided with a cam 150 serving as a locking member that rotates between an inner ring 120 serving as a first rotation element and an outer ring 110 serving as a second rotation element, and configured to be capable of transmitting rotation at a desired rotation angle.

The second clutch mechanism is a ratchet-type one-way clutch configured to be capable of transmitting rotation at a predetermined rotation angle by engaging ratchet teeth 141 provided in a ratchet tooth holding member 140 serving as a first engagement element with ratchet pawls 131 provided in a ratchet pawl holding member 130 serving as a second engagement element.

The ratchet pawls 131 are configured such that the ratchet pawls 131 engage the ratchet teeth 141 during relative rotation in one direction, while in the other direction, the relative distance between the ratchet pawls 131 and the ratchet teeth 141 changes and the ratchet pawls 131 pass over the ratchet teeth 141.

In this form, the ratchet pawls 131 have the same shape as the ratchet teeth 141, and the ratchet pawl holding member 130 and the ratchet tooth holding member 140 are configured to move relative to each other in an axial direction. However, each ratchet pawl 131 itself may be provided capable of swinging relative to the ratchet pawl holding member 130.

The ratchet pawl holding member 130 is fixed to an end surface of the outer ring 110. The ratchet tooth holding member 140 is fixed to the inner ring 120 and disposed extending in an outer circumferential direction from an end surface of the inner ring 120, with the ratchet pawls 131 and the ratchet teeth 141 disposed opposing each other in an axial direction.

Additionally, a side plate 151 is attached to the outer ring 110, and the axial direction position of the cam 150 constituting the first clutch mechanism is defined between the ratchet pawl holding member 130 and the side plate 151.

The operation mechanism that switches the operation of the first clutch mechanism includes a selector member 160 externally fitted to the inner ring 120 and capable of sliding in an axial direction on a selector sliding surface 122 of the inner ring 120.

An inner ring retaining plate 123, which restricts movement of the selector member 160 and prevents the inner ring 120 from falling out, is disposed at an end of the inner ring 120.

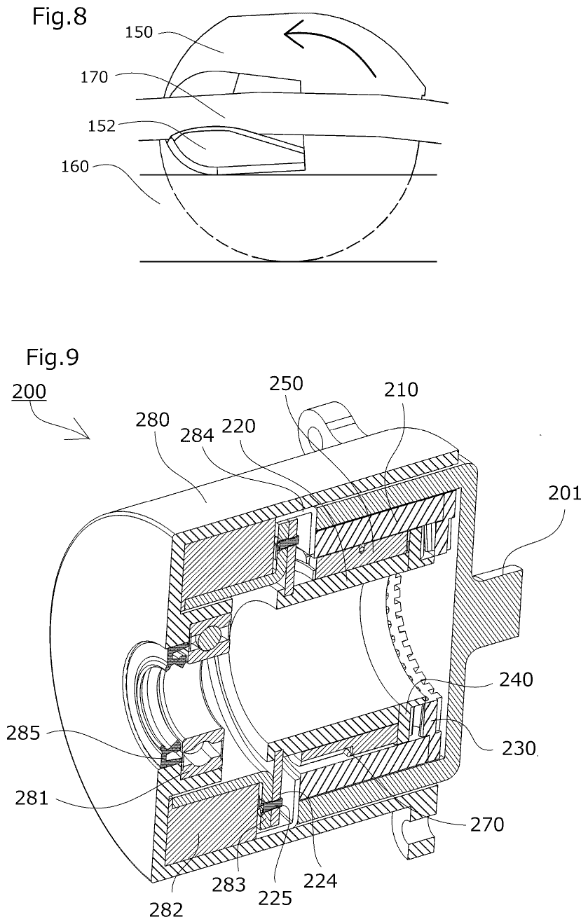

As illustrated in FIG. 8, in the first clutch mechanism, the cam 150 is biased toward the inner ring 120 while also being biased to rotate in the direction of the arrow in the figure by having a spring 170 hooked upon a pressing part 152, and is therefore in contact with both the inner ring 120 and the outer ring 110. The cam 150 blocks the transmission of rotational torque by permitting relative rotation of the inner ring 120 and the outer ring 110 in one direction, and prevents relative rotation of the inner ring 120 and the outer ring 110 in the other direction by rotating slightly in the direction of the arrow and engaging between cam sliding surfaces 111 and 121 of the inner ring 120 and the outer ring 110, respectively, to transmit rotational torque.

The selector member 160 is inserted below the pressing part 152 by sliding in the axial direction on the selector sliding surface 122 of the inner ring 120, and permits free relative rotation of the inner ring 120 and the outer ring 110 in both directions by keeping the cam 150 in a posture where no force is received from both the inner ring 120 and the outer ring 110 against the biasing force of the spring 170, which blocks the transmission of rotational torque in both directions.

The operation mechanism that switches the operation of the second clutch mechanism is configured to change an interval between the ratchet teeth 141 provided in the ratchet tooth holding member 140 and the ratchet pawls 131 provided in the ratchet pawl holding member 130 by moving the inner ring 120 itself relative to the outer ring 110 in the axial direction, to switch between a state in which the ratchet mechanism is operational and transmits rotation in only one direction, and a state in which the ratchet pawls 131 do not contact the ratchet teeth 141 and the transmission of rotational torque in both directions is blocked.

The inner ring retaining plate 123 and the selector member 160 described above restrict excessive sliding of the inner ring 120 during this switching operation.

Operations of the selectable clutch 100 according to the form of the clutch structure in which part of an operation mechanism is omitted, configured in this manner, will be described next.

The state illustrated in FIGS. 1, 2, 4, and 5 is a two-way free mode, in which the selector member 160 contacts the pressing part 152 of the cam 150 and the first clutch mechanism is free, and the inner ring 120 slides until the ratchet pawls 131 are not in contact with the ratchet teeth 141 and the second clutch mechanism is also free.

If, from this state, the selector member 160 is slid to take the selector member 160 out of contact with the pressing part 152 of the cam 150, the first clutch mechanism operates as a one-way clutch, establishing the one-way free mode.

Furthermore, when the selector member 160 is slid, the selector member 160 contacts the inner ring retaining plate 123 and slides together with the inner ring 120, enabling the ratchet pawls 131 and the ratchet teeth 141 to engage, and the second clutch mechanism operates as a one-way clutch for rotation in the opposite direction from the first clutch mechanism, establishing a two-way lock mode in which rotation is transmitted in both directions.

This operation may be performed by sliding the inner ring 120 directly.

This form is configured such that the selector member 160 of the first clutch mechanism is capable of contacting the pressing part 152 of the cam 150 only at the position of the inner ring 120 where the second clutch mechanism is in the free state. If the first clutch mechanism is switched from the two-way free mode by the selector member 160, the inner ring 120 can be slid in the same operation to switch the second clutch mechanism and establish the two-way lock mode directly.

When switching the mode from the two-way lock mode, sliding the selector member 160 causes the inner ring 120 to slide at the same time, setting the first and second clutch mechanisms to the free state and establishing the two-way free mode illustrated in FIGS. 1, 2, 4, and 5.

When switching the first clutch mechanism from the two-way free mode using the selector member 160, if the operation is stopped at a position where the inner ring 120 is not slid, the second clutch mechanism remains free and the one-way free mode is established.

In the stated form, the selector member 160 of the first clutch mechanism is capable of contacting the pressing part 152 of the cam 150 only at the position of the inner ring 120 where the second clutch mechanism is in the free state. However, as a configuration in which each can be switched independently, an opposite-direction one-way free mode in which only the second clutch mechanism operates as a one-way clutch may be provided, such that the modes can be switched among four modes.

Additionally, in the stated form, the operation mechanism of the first clutch mechanism is provided with the selector member 160 that can slide in the axial direction, and the operation mechanism of the second clutch mechanism is implemented by sliding the inner ring 120, but other publicly-known switching mechanisms may be used as well.

Additionally, in the stated form, the cam 150 serving as the first clutch mechanism may have a different shape depending on the required torque resistance or the like, and although a cam clutch having the first clutch mechanism has been described, a clutch configured to be capable of transmitting rotation at any rotation angle by slightly moving a roller or the like to engage between two rotation elements may be used as well.

Additionally, in the stated form, the second clutch mechanism is constituted by ratchet pawls 131 and ratchet teeth 141 opposing each other in the axial direction, but these pawls and teeth may instead oppose each other in a radial direction.

Furthermore, if the reverse-direction one-way free mode is not provided as in the form described above, a dog clutch shape lacking a one-way clutch function may be used as the second clutch mechanism.

The cam may have a different shape depending on the required torque resistance or the like.

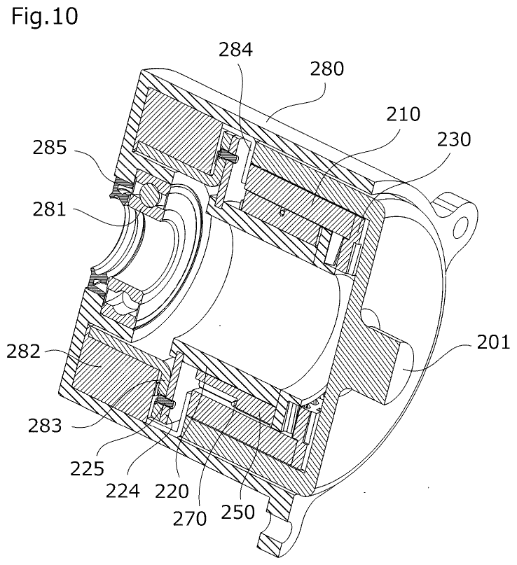

A selectable clutch according to an embodiment of the present invention will be described next with reference to FIGS. 9 and 10. Note, however, that the present invention is not limited by this embodiment.

In the present embodiment, although the dimensions of the first clutch mechanism, the second clutch mechanism, and part of the operation mechanism are different, the structures are the same as in the foregoing form, and the structures of identical members will therefore not be described in detail.

As illustrated in the cross-sectional perspective views in FIGS. 9 and 10, a selectable clutch 200 according to an embodiment of the present invention includes first and second clutch mechanisms that transmit and block rotation of a first shaft (not shown) and a second shaft 201 provided to be capable of relative rotation on the same axis, and an operation mechanism that switches operations of the first and second clutch mechanisms.

The first clutch mechanism is a cam clutch provided with a cam 250 serving as a locking member that rotates between an inner ring 220 serving as a first rotation element and an outer ring 210 serving as a second rotation element, and configured to be capable of transmitting rotation at any rotation angle.

The cam 250 is biased toward the inner ring 220 by a spring 270 being hooked on the cam 250.

The second clutch mechanism is a ratchet-type one-way clutch configured to be capable of transmitting rotation at a predetermined rotation angle by engaging ratchet teeth provided in a ratchet tooth holding member 240 serving as a first engagement element with ratchet pawls provided in a ratchet pawl holding member 230 serving as a second engagement element.

The ratchet tooth holding member 240 serving as the first engagement element is fixed to the inner ring 220, and the ratchet pawl holding member 230 serving as the second engagement element is fixed to the outer ring 210.

Note that the ratchet tooth holding member 240 and the inner ring 220, the ratchet pawl holding member 230 and the outer ring 210, or both may be fixed to enable a slight amount of relative rotation via an elastic member or the like for facilitating engagement and disengagement.

In the present embodiment, the arrangement of the ratchet tooth holding member and the ratchet pawl holding member is reversed in the axial direction from the form described above, and the inner ring 120 is disposed such that the two are engaged by pulling toward the selector member 160 in the form described above. However, in the present embodiment, the inner ring 220 is disposed such that the two are engaged by pressing in a direction away from an actuator 282 (described later).

The operation mechanism that switches the operation of the second clutch mechanism includes a main body part 280, an annular connection plate 224 provided unable to move in the axial direction to the inner ring 220 serving as the first rotation element, and a drive unit provided in the main body part 280 and driving the connection plate 224 in the axial direction.

The main body part 280 is configured to be capable of supporting the first shaft (not shown), which is a shaft member connected to the first rotation element by a bearing 281.

In the present embodiment, an oil seal 285 is provided parallel to the bearing 281.

The main body part 280 is formed in a shape enclosing the entire operation mechanism including the first clutch mechanism, the second clutch mechanism, and the actuator 282.

In the present embodiment, the second shaft 201 side of the main body part 280 has an open shape, but a cover member having a hole through which only the second shaft 201 passes may be provided integrally or separately to cover the entire second shaft 201 side. In this case, a bearing, an oil seal, and the like may be provided for the second shaft 201.

The drive unit includes the actuator 282 fixed to the main body part 280, a plunger 283 fixed to the connection plate 224 by a fixing bolt 225 and driven in the axial direction by the actuator 282, and a spacer 284 that maintains a gap in the axial direction between the outer ring 210, which is the second rotation element, and the actuator 282.

The connection plate 224 is fitted into a groove part of the inner ring 220 so as to be immovable in the axial direction and capable of rotation, and the inner ring 220 is driven in the axial direction by the actuator 282 driving the connection plate 224 and the plunger 283 together in the axial direction.

Note that the connection plate 224 is also fixed to the inner ring 220 in the rotational direction, and the plunger 283 may be configured to be capable of rotating relative to the actuator 282.

In a state where the inner ring 220 is located on the actuator 282 side as in the figures, the ratchet tooth holding member 240 and the ratchet pawl holding member 230 constituting the second clutch mechanism are spaced apart in the axial direction and are capable of rotating in both directions, and only the first clutch mechanism functions as a one-way clutch, in which as a whole, relative rotation in one direction is permitted and relative rotation in the opposite direction is prevented.

In a state where the inner ring 220 is moved in a direction away from the actuator 282, the ratchet tooth holding member 240 and the ratchet pawl holding member 230 constituting the second clutch mechanism engage, which prevents relative rotation in the direction permitted by the first clutch mechanism and transmits relative rotation of the first shaft (not shown) and the second shaft 201 in both directions.

Note that the spacer 284 is provided between the actuator 282 and the outer ring 210, which prevents the outer ring 210 from moving toward the actuator 282 when some kind of external force is applied and prevents the second clutch mechanism from operating unexpectedly.

In the present embodiment, by providing a member for biasing in a projection direction between the actuator 282 and the plunger 283, such as a spring washer or the like, the inner ring 220 moves in a direction away from the actuator 282 when drive force by the actuator 282 is cut, and the ratchet tooth holding member 240 and the ratchet pawl holding member 230 engage, whereas when the drive force by the actuator 282 is generated, the inner ring 220 moves in a direction toward the actuator 282, and the ratchet tooth holding member 240 and the ratchet pawl holding member 230 separate (the state illustrated in the figures).

Accordingly, the actuator 282 can be configured as a simple structure that generates drive force in one direction only, e.g., a simple coil (electromagnet), and pulls the plunger 283 in when energized and turned on.

The direction in which the actuator 282 generates the drive force and the biasing direction may be reversed, and the actuator 282 may be capable of generating and holding drive force in both directions, such that the biasing member may be omitted.

The drive force of the drive unit may be generated by any power source, such as electromagnetic force, fluid pressure, or the like. The drive unit is also not limited to being constituted by the actuator 282 and the plunger 283, and may be another type of reciprocating drive unit.

In the present embodiment, using a coil (an electromagnet) as the actuator 282 and disposing the actuator 282, the plunger 283, and the connection plate 224 in an annular shaped around the first shaft (not shown) makes it possible to transmit the drive force evenly around the entire circumference of the inner ring 220, reduce the drive force for the switching, and make the actuator 282 more compact and consume less power.

While the embodiments of the present invention have been described in detail, the present invention is not limited to the above embodiments, and various design changes can be made without departing from the invention recited in the aspects.

For example, as in one form of the stated clutch structure in which part of the operation mechanism is omitted, a selector member may also be provided in the first clutch mechanism to enable switching, and the modes may be switched among three or more modes by using an actuator configuration that can be moved between and fixed in multiple stages such that the operations of the selector member and the operations of the inner ring are performed in stages.

What is claimed is:

1. A selectable clutch comprising at least one clutch mechanism that transmits and blocks rotation of a first shaft and a second shaft provided to be capable of relative rotation on the same axis and an operation mechanism that switches an operation of the at least one clutch mechanism, the selectable clutch capable of switching between transmitting and blocking the relative rotation of the first shaft and the second shaft,
wherein the clutch mechanism includes a first rotation element fixed in a rotation direction with the first shaft, and a second rotation element rotationally fixed to the second shaft,
the operation mechanism includes a main body part, an annular connection plate provided unable to move in an axial direction with the first rotation element, and a drive unit provided in the main body part and driving the connection plate in the axial direction, and
the main body part is configured to be capable of supporting a shaft member connected to the first rotation element or the second rotation element by a bearing.

2. The selectable clutch according to claim 1,
wherein the drive unit includes an actuator fixed to the main body part, a plunger fixed to the connection plate and driven in the axial direction by the actuator, and a spacer that maintains a gap between the second rotation element and the actuator in the axial direction.

3. The selectable clutch according to claim 2,
wherein the actuator, the plunger, and the connection plate are disposed in an annular shape around the first shaft.

4. The selectable clutch according to claim 1,
wherein the main body part is formed in a shape enclosing the clutch mechanism and the operation mechanism.

5. The selectable clutch according to claim 1,
wherein the clutch mechanism includes a first clutch mechanism and a second clutch mechanism,
the first clutch mechanism includes a locking member that moves and/or rotates between the first rotation element and the second rotation element, and is configured to be capable of transmitting rotation at any rotation angle, and
the second clutch mechanism is configured to be capable of transmitting rotation at a predetermined rotation angle by engaging a first engagement element with a second engagement element.

6. The selectable clutch according to claim 5,
wherein the first rotation element and the second rotation element are configured as an outer ring and an inner ring, respectively, disposed in positions overlapping in the axial direction,
the locking member is a cam, and
the first clutch mechanism includes a plurality of the cams provided in a circumferential direction between the outer ring and the inner ring, and a biasing member that biases the plurality of the cams.

7. The selectable clutch according to claim 6,
wherein the operation mechanism includes a selector member that can be switched to permit or prevent rotation of the cams.

8. The selectable clutch according to claim 5,
wherein the first engagement element and the second engagement element are arranged to oppose each other, one having ratchet teeth and the other having ratchet pawls.

9. The selectable clutch according to claim 5,
wherein the first rotation element and the second rotation element are configured as an outer ring and an inner ring, respectively, disposed in positions overlapping in the axial direction,
the first engagement element and the second engagement element are arranged to oppose each other in the axial direction,
the first engagement element is constituted by a plurality of ratchet pawls provided on an end surface of the outer ring, and
the second engagement element is constituted by ratchet teeth arranged to extend in an outer circumferential direction from an end surface of the inner ring.
